(19) United States
(12) Patent Application Publication
(10) Pub. No.: US 2017/0317447 A1
(43) Pub. Date: Nov. 2, 2017

(54) PLUG HOLDER

(71) Applicant: AVER INFORMATION INC., New Taipei City (TW)

(72) Inventors: Shu-Chen CHEN, New Taipei City (TW); Hui-Lun HUNG, New Taipei City (TW)

(73) Assignee: AVER INFORMATION INC., New Taipei City (TW)

(21) Appl. No.: 15/498,693

(22) Filed: Apr. 27, 2017

(30) Foreign Application Priority Data
Apr. 29, 2016 (TW) 105113434

(51) Int. Cl. H01R 13/639; H01R 13/62

(52) U.S. Cl. CPC H01R 13/639; H01R 13/6205

(57) ABSTRACT

A plug holder is for positioning a connector-cable assembly to an electronic device. The connector-cable assembly includes a plug connector and a cable. The plug holder includes a first accommodating member, a pressing member and at least one magnetic member. The first accommodating member has a first accommodating space. The pressing member is connected to a side of the first accommodating member. The pressing member has a pressing surface facing the first accommodating member and extending from an inner surface of the first accommodating member. The magnetic member is located on a side of the first accommodating member which is away from the pressing member.

### CROSS-REFERENCE TO RELATED APPLICATIONS

This non-provisional application claims priority under 35 U.S.C. §119(a) on Patent Application No(s). 105113434 filed in Taiwan, R.O.C. on Apr. 29, 2016, the entire contents of which are hereby incorporated by reference.

### TECHNICAL FIELD

The disclosure relates to a plug holder, more particularly to a plug holder having at least one magnetic member.

### BACKGROUND

With the development of technology, electronic devices such as tablet computers, desktop computers, all-in-one computers, conference phones, data storing devices or portable media players are widely used in daily life. In addition, each electronic device requires a specialized connector-cable assembly for transmitting signal data or receiving electrical power.

However, the configurations of the connector-cable assemblies from different manufacturers are slightly different from one another, so the sizes of female or male plug connectors of the connector-cable assemblies are not well matched to a port (or a receptacle connector) on the corresponding electronic device. Consequently, the connector-cable assemblies have a poor connection to the electronic device and are easily unplugged from the electronic device. Furthermore, the plug connector of the connector-cable assembly may become loose during repeated insertion and removal of the plug connector from a corresponding port, which results in a poor connection as well.

### SUMMARY

The present disclosure provides a plug holder for preventing the connector-cable assembly from being accidentally unplugged from the electronic device and maintaining the position of the connector-cable assembly with respect to the electronic device.

One embodiment of the disclosure provides a plug holder configured for positioning a connector-cable assembly with respect to an electronic device. The connector-cable assembly includes a plug connector and a cable coupled to the plug connector. The plug holder includes a first accommodating member, a pressing member and at least one magnetic member. The first accommodating member has a first accommodating space configured for accommodating the plug connector of the connector-cable assembly. The pressing member is connected to a side of the first accommodating member. The pressing member has a pressing surface facing the first accommodating member and extending from an inner surface of the first accommodating member. The magnetic member is located on a side of the first accommodating member which is away from the pressing member. When the magnetic member is closed to the electronic device, the at least one magnetic member is magnetically attracted to the electronic device, and the pressing surface of the pressing member presses a side of the plug connector coupled to the cable so as to move the plug connector toward the electronic device.

According to the plug holder as discussed above, when the magnetic member is closed to the electronic device, there is a magnetic attraction generated between the magnetic member and the electronic device so that the pressing surface of the pressing member presses the plug connector toward the electronic device. Therefore, the physical connection between the plug connector and the electronic device is stronger so that the plug connector is prevented from being accidentally unplugged from the electronic device and maintained to be at its predetermined position, and thereby the electrical interconnection between the connector-cable assembly and the electronic device is maintained in a desired quality.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a schematic view of a plug holder disposed on a connector-cable assembly according to a first embodiment of the disclosure;

FIG. 2A and FIG. 2B are exploded views of the plug holder and the connector-cable assembly in FIG. 1;

FIG. 3 is a top view of the plug holder disposed on the connector-cable assembly according to the first embodiment of the disclosure;

FIG. 4A is a front view of the plug holder disposed on the connector-cable assembly according to the first embodiment of the disclosure;

FIG. 4B is a cross-sectional back view of the plug holder disposed on the connector-cable assembly according to the first embodiment of the disclosure;

FIG. 5A and FIG. 5B are schematic views showing the usage of the plug holder according to the first embodiment of the disclosure; and

FIG. 6 is a schematic view of a plug holder disposed on the connector-cable assembly according to a second embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

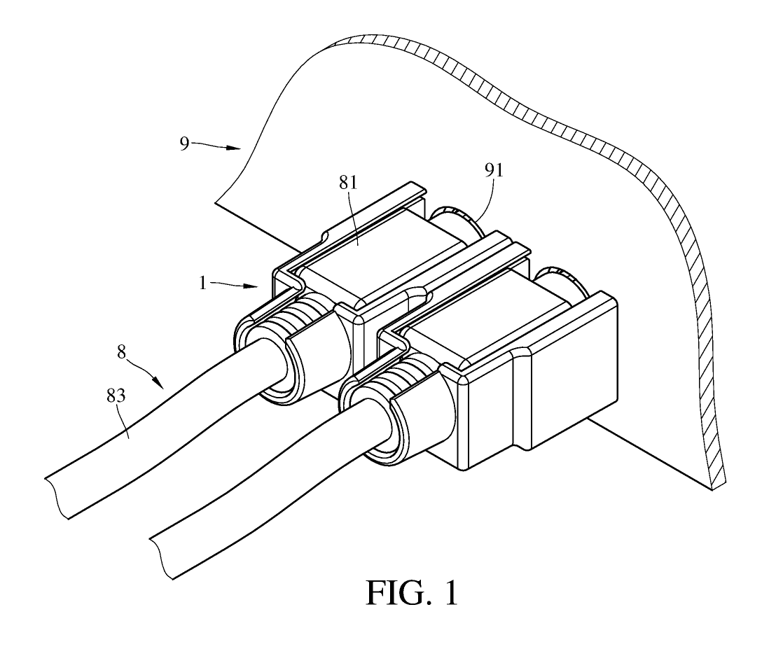

Please refer to FIG. 1, which is a schematic view of a plug holder disposed on a connector-cable assembly according to a first embodiment of the disclosure. As shown in FIG. 1, a plug holder 1 is provided. The plug holder 1 is configured for positioning a connector-cable assembly 8 with respect to an electronic device 9. In this embodiment, the connector-cable assembly 8 is, for example, a signal connector-cable assembly for data transmission. The connector-cable assembly 8 includes a plug connector 81 and an associated cable 83 coupled to the plug connector 81. The plug connector 81 is a terminal connector such as a separate video (S-Video) connector, but the present disclosure is not limited to the types of the plug connector 81. In addition, the connector-cable assembly 8 is not limited to be a signal connector-cable assembly. In other embodiments, the connector-cable assembly can be a power connector-cable assembly for transporting electrical power. The said electronic device 9 is, for example, a tablet computer, a desktop computer, an all-in-one computer, a conference phone, a data storing device or a portable media player. The electronic device 9 has a port 91 which is a receptacle for receiving and holding the plug connector 81, but the present disclosure is not limited to the configuration of the port 91. Thus, the plug connector 81 is able to be plugged into the port 91, Furthermore, a part of a casing (not numbered) of the electronic device 9 around the port 91 contains magnetic substances, such as iron, cobalt, nickel or other metal alloys, which can attract magnet.

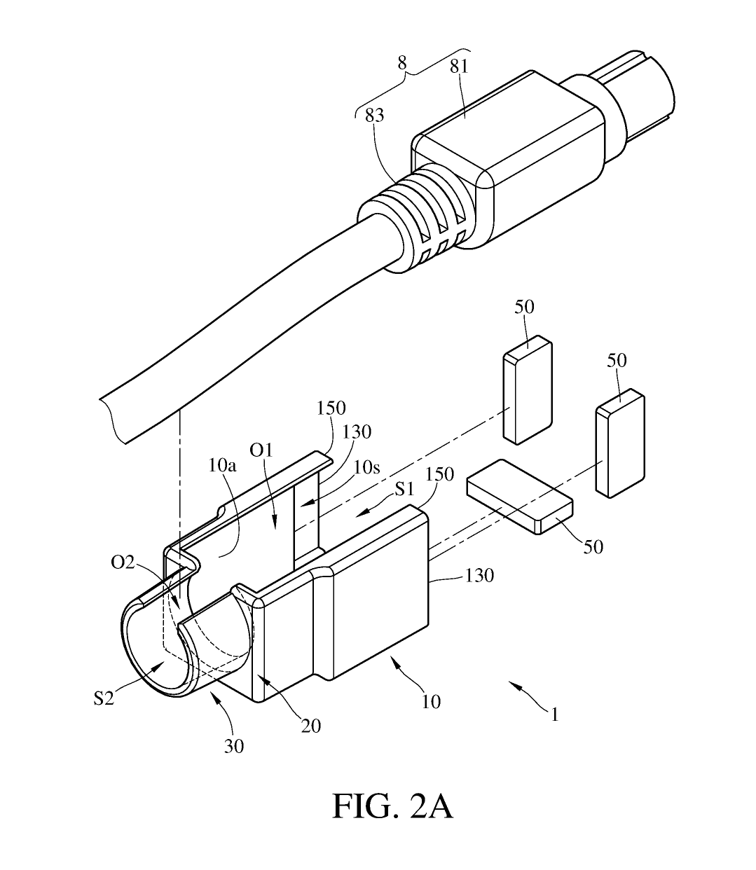

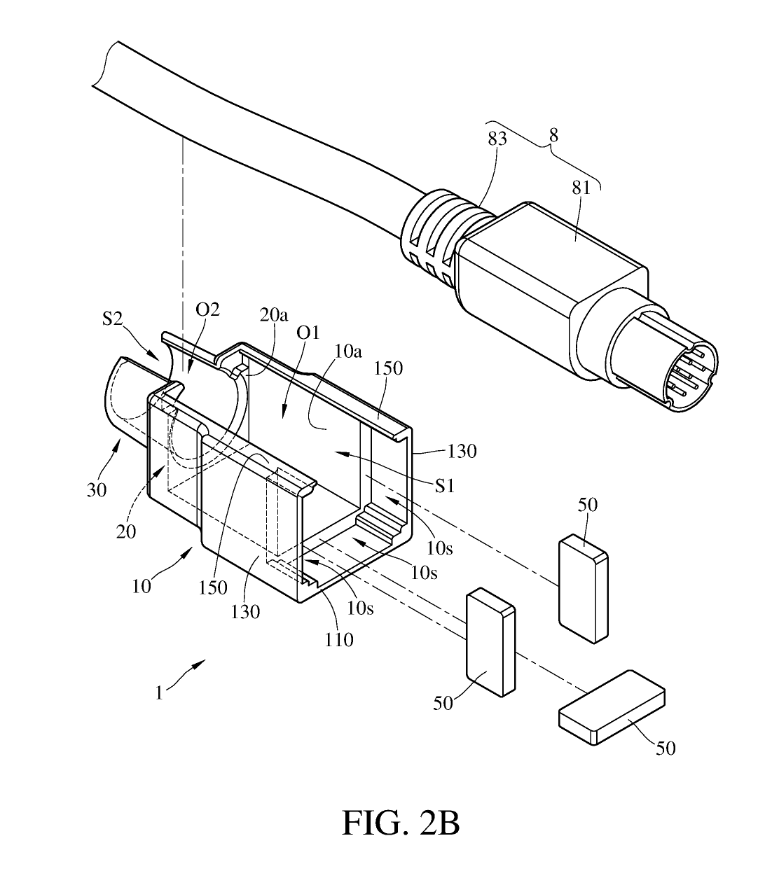

Then, please refer to FIGS. 2A-2B, which are exploded views of the plug holder and the connector-cable assembly in FIG. 1. As shown in FIG. 2A-2B, the plug holder 1 includes a first accommodating member 10, a pressing member 20, a second accommodating member 30 and a plurality of magnetic members 50. The pressing member 20 is connected between the first accommodating member 10 and the second accommodating member 30. The magnetic member 50 is disposed on a side of the first accommodating member 10 which is opposite to the pressing member 20. The first accommodating member 10, the pressing member 20 and the second accommodating member 30 are integral into a signal piece, but the present disclosure is not limited thereto. In other embodiments, the first accommodating member 10, the pressing member 20 and the second accommodating member 30 may be three independent pieces. In addition, the first accommodating member 10, the pressing member 20 and the second accommodating member 30 are made of, for example, deformable or flexible material such as plastic or rubber.

In detail, the first accommodating member 10 includes a bottom plate portion 110, two side plate portions 130 and two extending portions 150. The two side plate portions 130 are respectively disposed on two sides of the bottom plate portion 110 which are opposite to each other. The two extending portions 150 are respectively disposed on the two side plate portions 130 and are opposite to the bottom plate portion 110. One of the extending portions 150 extends toward the other extending portion 150. The bottom plate portion 110, the two side plate portions 130 and the two extending portions 150 together define a first accommodating space S1 for accommodating the plug connector 81 of the connector-cable assembly 8. In addition, the first accommodating space S1 has an opening O1 defined by the two extending portions 150. Furthermore, the first accommodating member 10 has three recesses 10s. The three recesses 10s are respectively located on the bottom plate portion 110 and the two side plate portions 130, and the three recesses 10s are located on a side of the first accommodating member 10 which is away from the pressing member 20. Moreover, the present disclosure is not limited to the appearance of the first accommodating member 10 and the shape of the first accommodating space S1 therein. In other embodiments, the shape of the first accommodating space S1 can be square, rectangle, round or polygonal for matching the shape of the plug connector 81 of the connector-cable assembly 8.

The pressing member 20 has a pressing surface 20a located on a side of the pressing member 20 which faces the first accommodating member 10. In addition, the pressing surface 20a extends from an inner surface 10a of the first accommodating member 10.

The second accommodating member 30 has a second accommodating space S2 connected to the first accommodating space S1. The second accommodating space S2 is configured for accommodating a part of the cable 83 of the connector-cable assembly 8. In addition, the second accommodating space S2 has an opening O2, and the cable 83 is able to enter into the second accommodating space S2 from the opening O2.

The magnetic member 50 is, for example, a natural magnet or an artificial magnet and is able to produce a magnetic field so that the magnetic member 50 is able to attract magnetic substances which can be magnetized. The three magnetic members 50 are respectively disposed in the three recesses 10s. In other words, the three magnetic members 50 are respectively disposed on three different sides of the first accommodating member 10. However, the present disclosure is not limited to the locations and the quantities of the magnetic members 50 and the recesses 10s. Furthermore, the present disclosure is not limited to the quantity of the magnetic member 50 located in single recess 10s. In another embodiment, the quantity of the magnetic member 50 and the quantity of the recess 10s can be one, and this recess 10s can be located on one of the bottom plate portion 110 and the side plate portions 130. In yet another embodiment, two or more magnetic members 50 can be disposed in single recess 10s.

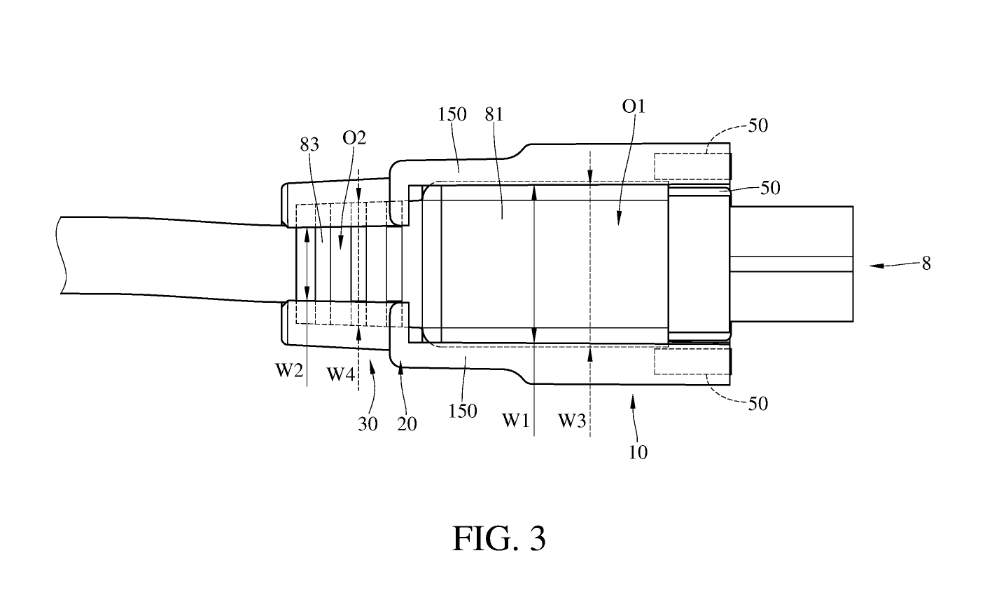

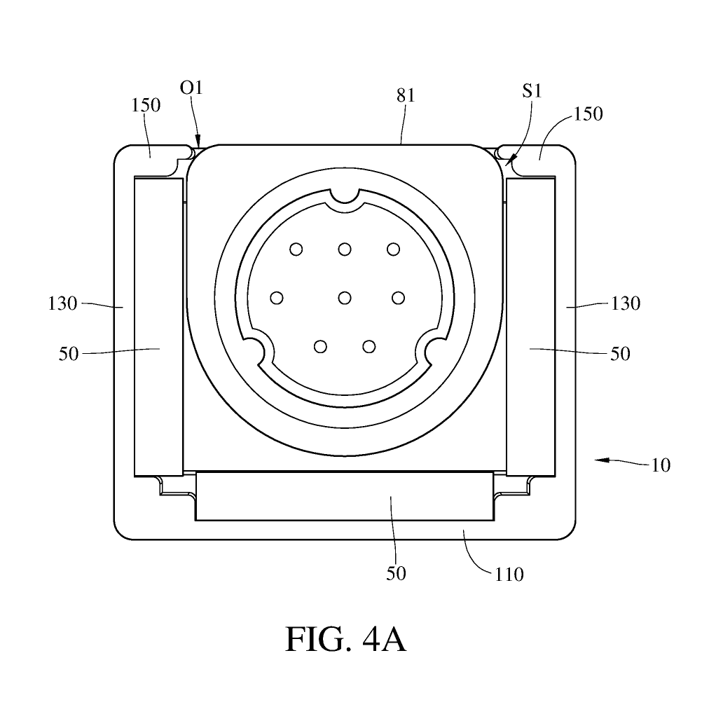

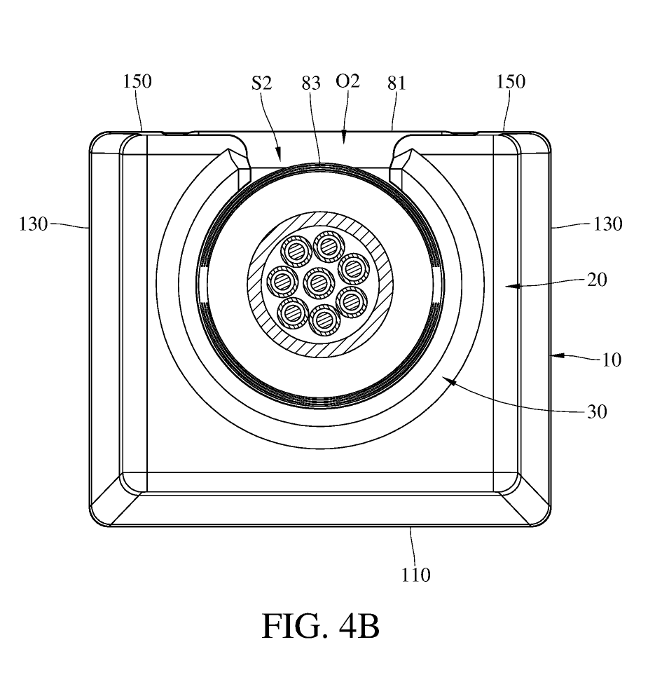

Then, please refer to FIG. 3-4B, FIG. 3 is a top view of the plug holder disposed on the connector-cable assembly according to the first embodiment of the disclosure, FIG. 4A is a front view of the plug holder disposed on the connector-cable assembly according to the first embodiment of the disclosure, and FIG. 4B is a cross-sectional back view of the plug holder disposed on the connector-cable assembly according to the first embodiment of the disclosure.

As shown in FIG. 3, in this embodiment, a width W1 of the opening O1 of the first accommodating space S1 is less than a width W3 of the plug connector 81 of the connector-cable assembly 8. A width W2 of the opening O2 of the second accommodating space S2 is less than a width W4 of the cable 83 of the connector-cable assembly 8.

Thus, as shown in FIG. 4A, when the plug connector 81 of the connector-cable assembly 8 is accommodated in the first accommodating space S1 of the first accommodating member 10, the two extending portions 150 can prevent the plug connector 81 from passing through the opening O1 so that the plug connector 81 is prevented from moving away from the first accommodating member 10, and thereby the plug connector 81 is kept in the first accommodating space S1. Similarly, as shown in FIG. 4B, when the cable 83 of the connector-cable assembly 8 is accommodated in the second accommodating space S2 of the second accommodating member 30, the second accommodating member 30 keeps the cable 83 in the second accommodating space S2.

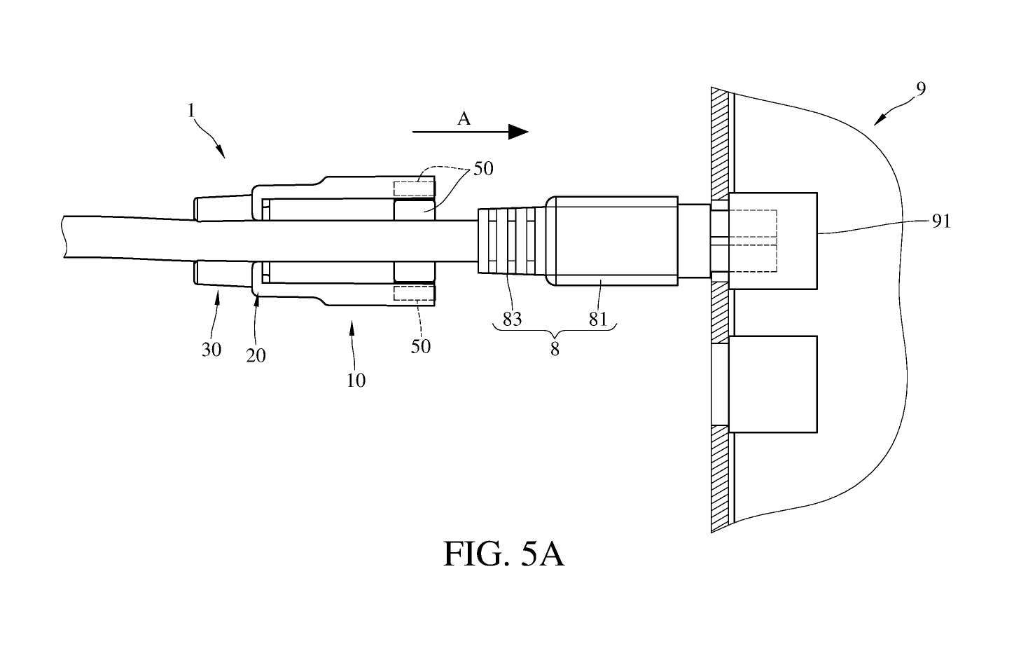

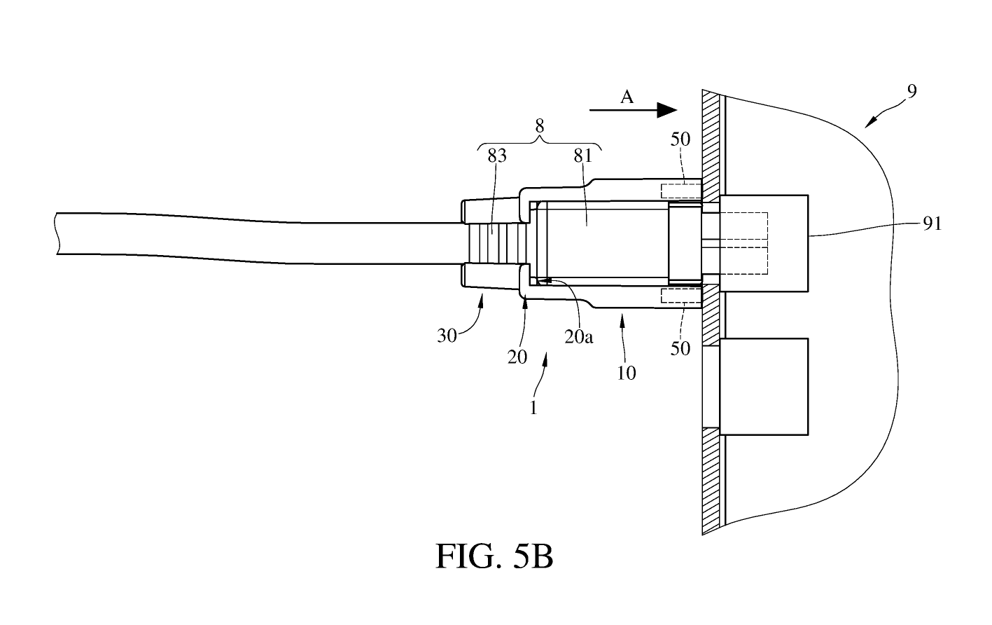

Then, please refer to FIG. 5A-5B, which are schematic views showing the usage of the plug holder according to the first embodiment of the disclosure.

Firstly, as shown in FIG. 5A, the plug connector 81 of the connector-cable assembly 8 is plugged into the port 91 of the electronic device 9, and the second accommodating member 30 is disposed on the cable 83 of the connector-cable assembly 8. The user is able to slide the plug holder 1 along the cable 83 in a direction of arrow A to approach the electronic device 9. Since the width W2 of the opening O2 of the second accommodating space S2 is less than the width W4 of the cable 83 of the connector-cable assembly 8, the second accommodating member 30 is not easily separated from the cable 83 when the plug holder 1 slides on the cable 83.

Then, as shown in FIG. 5B, the magnetic members 50 and the electronic device 9 are close enough so that the magnetic members 50 are strongly magnetically attracted to the electronic device 9. In such a case, the magnetic members 50 can pull the rest of the plug holder 1 toward the electronic device 9 so that the pressing surface 20a of the pressing member 20 generates a pressing force in the direction of arrow A onto a side of the plug connector 81 coupled to the cable 83. Therefore, the plug holder 1 constantly presses the plug connector 81 toward the electronic device 9. Accordingly, although the configurations of the connector-cable assemblies from different manufacturers are slightly different from one another, or the plug connector 81 may become loose over time, the plug connector 81 still can be firmly fixed to the electronic device 9 by the force applied on the plug connector 81 (i.e. the magnetic attraction generated between the plug holder 1 and the electronic device 9) for maintaining the quality of the electrical interconnection between the connector-cable assembly 8 and the electronic device 9. That is, by using the plug holder 1, the physical connection between the plug connector 81 and the electronic device 9 can be stronger, so the connector-cable assembly 8 is prevented from being accidentally unplugged from the electronic device 9 and maintained to be at its predetermined position.

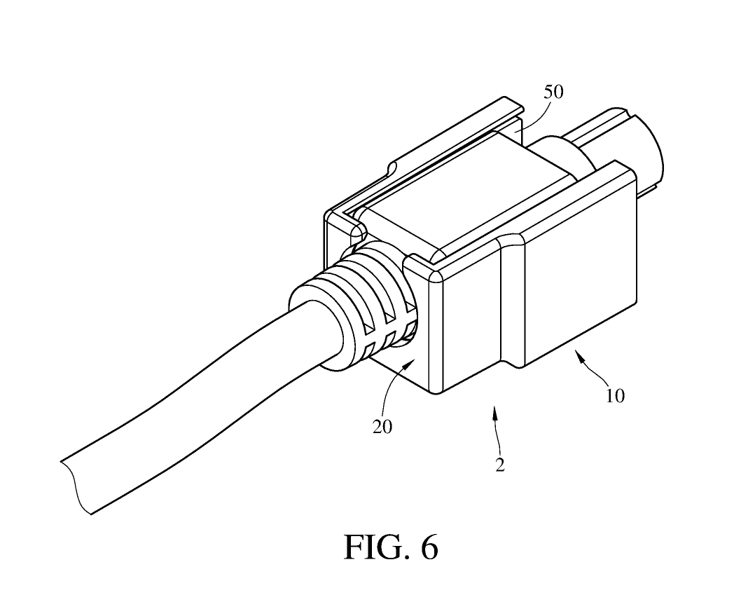

Furthermore, the present disclosure is not limited to the second accommodating member 30. For example, please refer to FIG. 6, which is a schematic view of a plug holder disposed on the connector-cable assembly according to a second embodiment of the disclosure. As shown in FIG. 6, a plug holder 2 is provided. The plug holder 2 is similar to the plug holder 1 of the first embodiment, but the plug holder 2 has no second accommodating member 30.

According to the plug holder as discussed above, when the magnetic members are closed to the electronic device, there is a magnetic attraction generated between the magnetic members and the electronic device so that the pressing surface of the pressing member presses the plug connector of the connector-cable assembly toward the electronic device. Therefore, the physical connection between the plug connector and the electronic device is stronger so that the plug connector is prevented from being accidentally unplugged from the electronic device and maintained to be at its predetermined position, and thereby the electrical interconnection between the connector-cable assembly and the electronic device is maintained in a desired quality.

In addition, by the configurations of the first accommodating member, the second accommodating member and the magnetic member, it is convenient for the user to dispose the plug holder on the connector-cable assembly and position the connector-cable assembly with respect to the electronic device.

The embodiments were chosen and described in order to best explain the principles of the disclosure and its practical applications, to thereby enable others skilled in the art to best utilize the disclosure and various embodiments with various modifications as are suited to the particular use contemplated. It is intended that the scope of the disclosure be defined by the following claims and their equivalents.

What is claimed is:

1. A plug holder configured for positioning a connector-cable assembly with respect to an electronic device, the connector-cable assembly comprising a plug connector and a cable coupled to the plug connector, the plug holder comprising:
a first accommodating member having a first accommodating space configured for accommodating the plug connector of the connector-cable assembly;
a pressing member connected to a side of the first accommodating member, the pressing member having a pressing surface, the pressing surface facing the first accommodating member and extending from an inner surface of the first accommodating member; and
at least one magnetic member located on a side of the first accommodating member which is away from the pressing member, when the at least one magnetic member is closed to the electronic device, the at least one magnetic member is magnetically attracted to the electronic device, and the pressing surface of the pressing member presses a side of the plug connector coupled to the cable so as to move the plug connector toward the electronic device.

2. The plug holder according to claim 1, wherein a width of an opening of the first accommodating space is less than a width of the plug connector of the connector-cable assembly.

3. The plug holder according to claim 1, further comprising a second accommodating member disposed on a side of the pressing member which is opposite to the first accommodating member, the second accommodating member having a second accommodating space configured for accommodating a part of the cable of the connector-cable assembly, wherein a width of an opening of the second accommodating space is less than a width of the cable of the connector-cable assembly.

4. The plug holder according to claim 1, wherein the at least one magnetic member is plural in number, and the magnetic members are disposed on different sides of the first accommodating member.

5. The plug holder according to claim 1, wherein the first accommodating member comprises a bottom plate portion and two side plate portions, and the two side plate portion are respectively disposed on two sides of the bottom plate portion which are opposite to each other.

6. The plug holder according to claim 5, wherein the first accommodating member further comprises two extending portions, the two extending portions are respectively disposed on the two side plate portions, one of the two extending portions extends toward the other one of the two extending portions, the bottom plate portion, the two side plate portions and the two extending portions together define the first accommodating space.

7. The plug holder according to claim 5, wherein the first accommodating space has an opening, the two extending portions together define the opening, and a width of the opening of the first accommodating space is less than a width of the plug connector of the connector-cable assembly.

8. The plug holder according to claim 5, wherein the first accommodating member has three recesses respectively located on the bottom plate portion and the two side plate portions, the three recesses are located on a side of the first accommodating member which is away from the pressing member, the at least one magnetic member is plural in number, and the magnetic members are respectively disposed on the three recesses.
